(19) United States
(12) Patent Application Publication
(10) Pub. No.: US 2003/0047854 A1
(43) Pub. Date: Mar. 13, 2003

(54) Detachable and replaceable shock damper for use in structures

(76) Inventors: Chong-Shien Tsai, Taipei (TW); Lap Lai Chung, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/949,574

(22) Filed: Sep. 11, 2001

(51) Int. Cl. F16M 1/00; F16M 3/00

(52) U.S. Cl. 267/136; 188/378

(57) ABSTRACT

A shock damper includes a damper body installed in the frame of a structure and adapted to absorb earthquake shocks, and braces adapted to support the damper body in the frame of the structure, the damper body having a horizontal top plate, a horizontal bottom plate, and a vertical connecting device connected between the horizontal top plate and the horizontal bottom plate, the connecting device being a shaft formed of any of a variety of cross sections, or a plurality of plates of any of a variety of profiles.

### BACKGROUND OF THE INVENTION

1. Field of the Invention

The present invention relates to shock dampers for installation in a structure to absorb shocks and, more particularly, to a detachable and replaceable shock damper, which can be detachable and replaceable in a structure.

2. Description of the Related Art

An earthquake is a shaking of the crust of the earth, caused by underground volcanic forces or by shifting of rock. When an earthquake occurs in a residential area, it may cause disaster. Therefore, there are special terms strictly defined according to the law to build structures in areas where earthquake may occur frequently, i.e., buildings in areas where earthquake may occur frequently must be strong enough to bear earthquake shocks of a certain grade. Various earthquake protective structural materials and techniques have been developed for this purpose.

### SUMMARY OF THE INVENTION

The present invention has been accomplished under the circumstances in view. It is one object of the present invention to provide a shock damper for structures, which effectively absorbs earthquake shocks. It is another object of the present invention to provide a shock damper for structures, which is detachable and replaceable. To achieve these and other objects of the present invention, the shock damper comprises a damper body installed in the frame of a structure to absorb earthquake shocks, and braces to support the damper body in the frame of the structure, the damper body having a horizontal top plate, a horizontal bottom plate, and a vertical connecting device connected between the horizontal top plate and the horizontal bottom plate, the connecting device being a shaft formed of any of a variety of cross sections, or a plurality of plates of any of a variety of profiles.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a shock damper constructed according to one embodiment of the present invention.

FIG. 2 shows one installation example of the shock damper shown in FIG. 1.

FIG. 3A is an installed view of an alternate form of the shock damper according to the present invention.

FIG. 3B is an installed view of another alternate form of the shock damper according to the present invention.

FIGS. 4A˜4H are installed views of other different alternate forms of the shock damper according to the present invention.

FIGS. 5A˜5F are installed views of still other different alternate forms of the shock damper according to the present invention.

FIGS. 6A˜6I are top views showing different alternate forms of the shock damper according to the present invention.

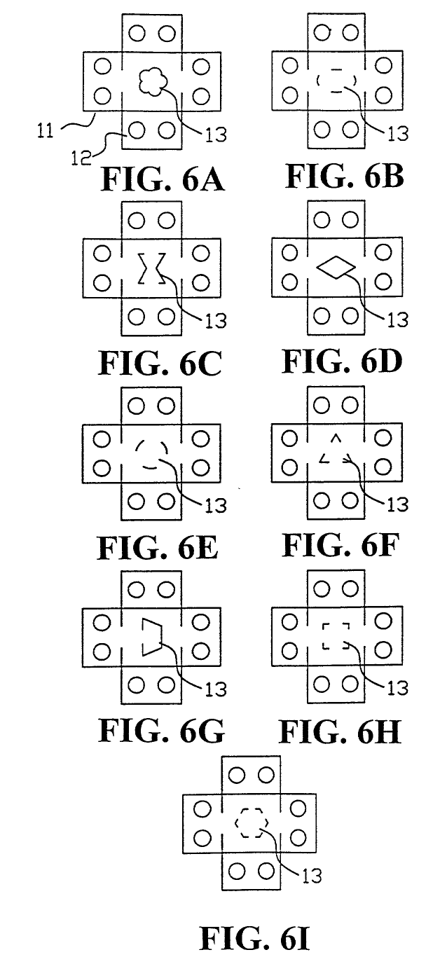

FIGS. 7A˜7H are perspective views showing different alternate forms of the damper body according to the present invention.

FIGS. 8A and 8B are exploded and perspective views of still another different alternate form of the damper body according to the present invention.

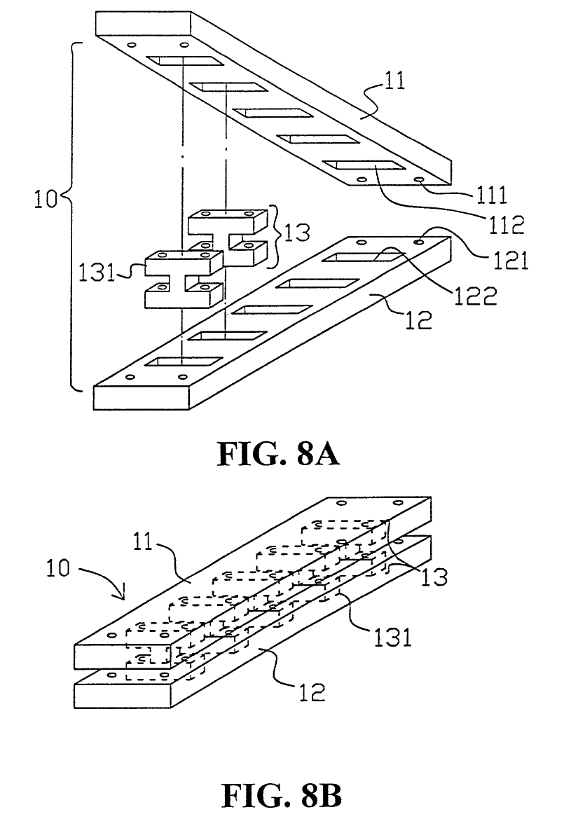

FIGS. 8C and 8D are exploded and perspective views of still another different alternate form of the damper body according to the present invention.

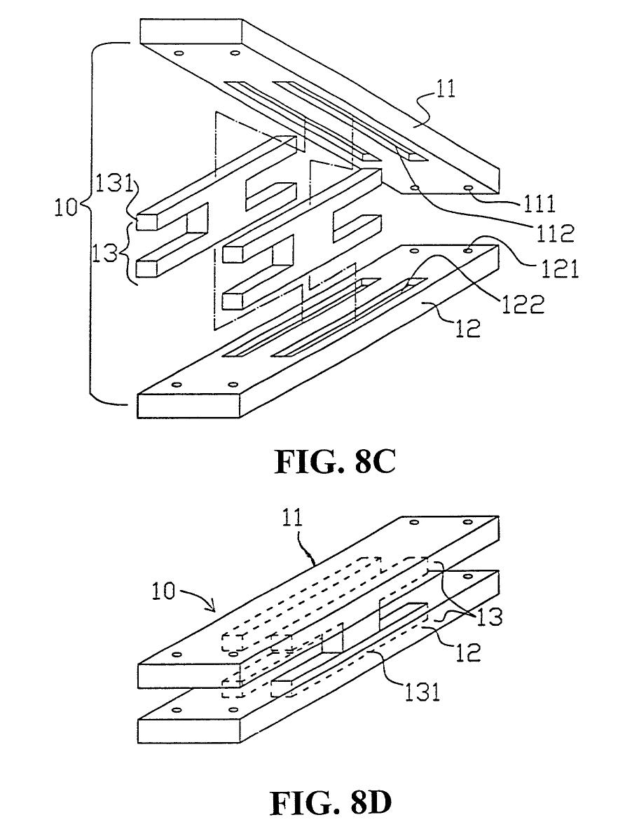

FIGS. 9A and 9B are exploded and perspective views of still another alternate form of the connecting device for the damper body according to the present invention.

FIGS. 10A and 10B are respective view of still another two alternate forms of the damper body according to the present invention.

FIG. 11 is shockwave curves obtained from an earthquake simulation vibration table with and without the effect of the present invention under the E1 Center 1940 Earthquake. The upper figures show shockwave curves without the effect of the present invention. The lower figures show shockwave curves with the effect of the present invention. It proves that most seismic energy is absorbed by the present invention.

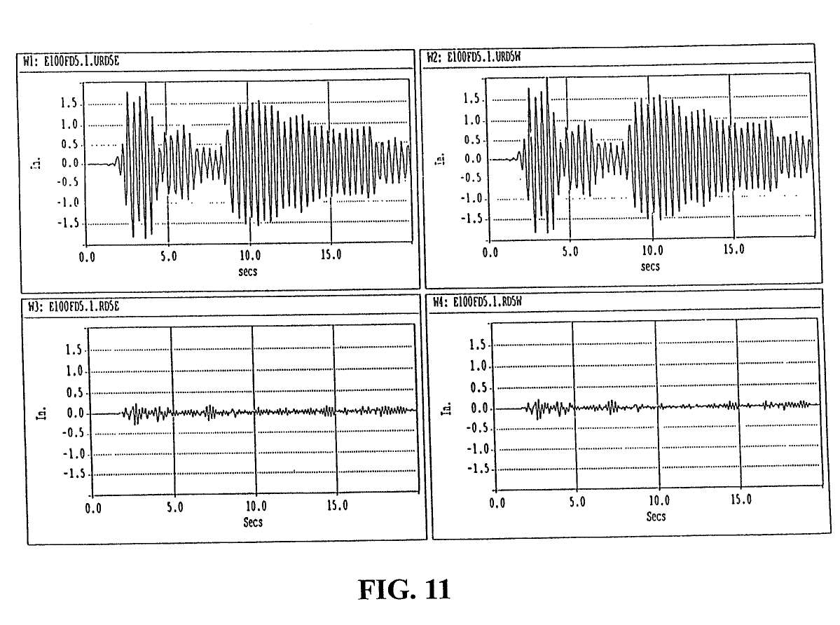

FIG. 12 is shockwave curves obtained from an earthquake simulation vibration table with and without the effect of the present invention under the doubled E1 Center 1940 Earthquake. The upper figures show shockwave curves without the effect of the present invention. The lower figures show shockwave curves with the effect of the present invention. It proves that most seismic energy is absorbed by the present invention.

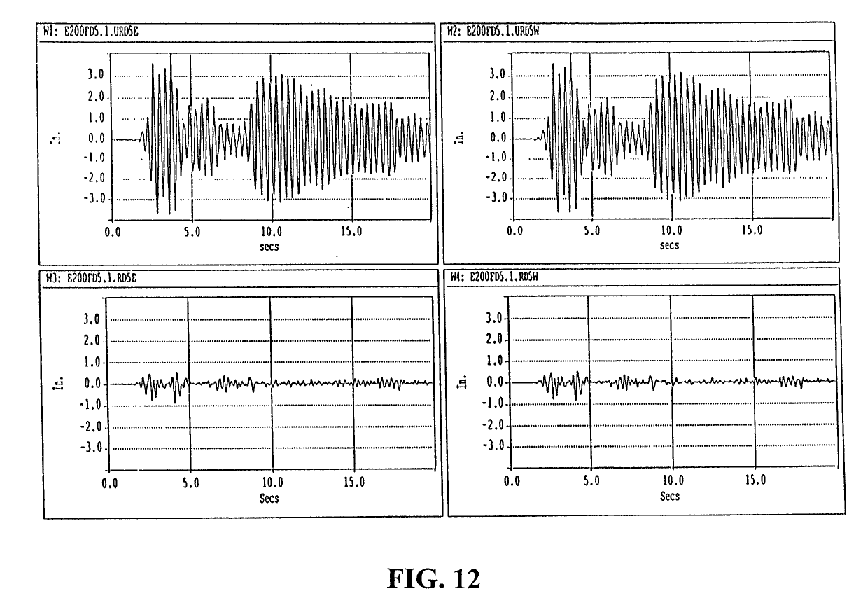

### DETAILED DESCRIPTION OF THE PREFERRED EMBODIMENT

For the purpose of promoting an understanding of the principles of the invention, reference will now be made to the embodiment illustrated in the drawings. Specific language will be used to describe the same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

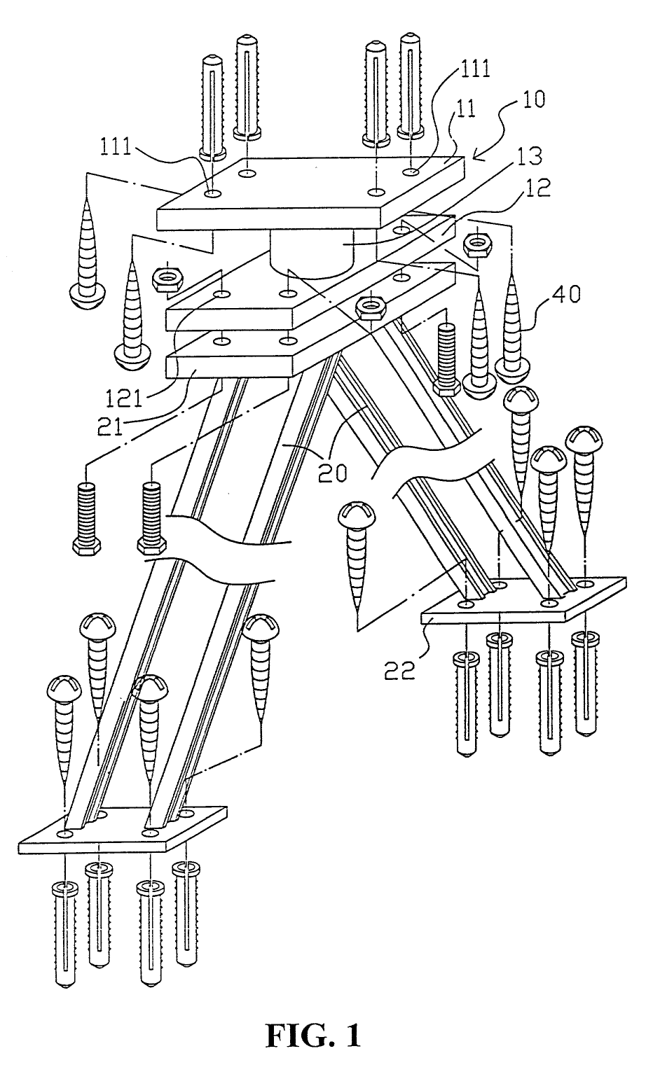

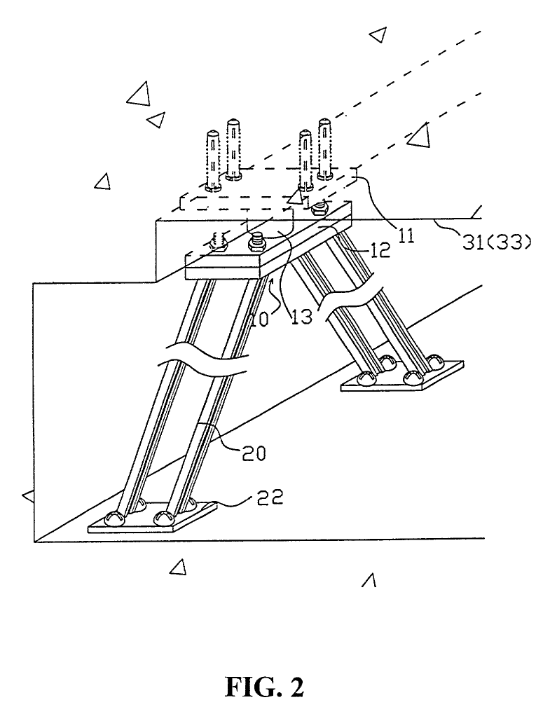

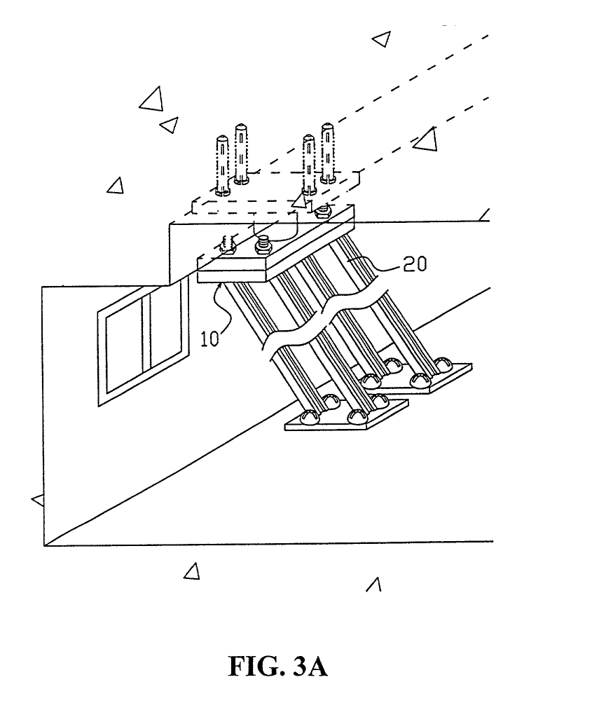

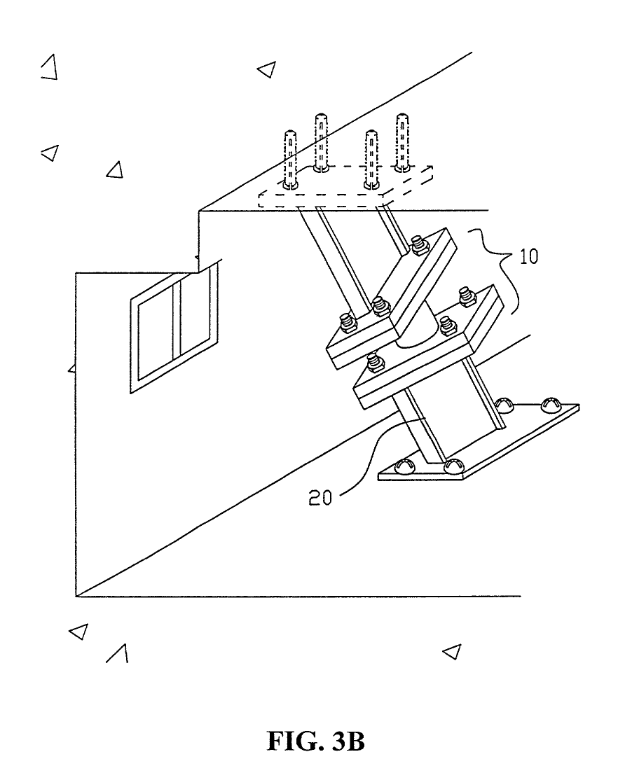

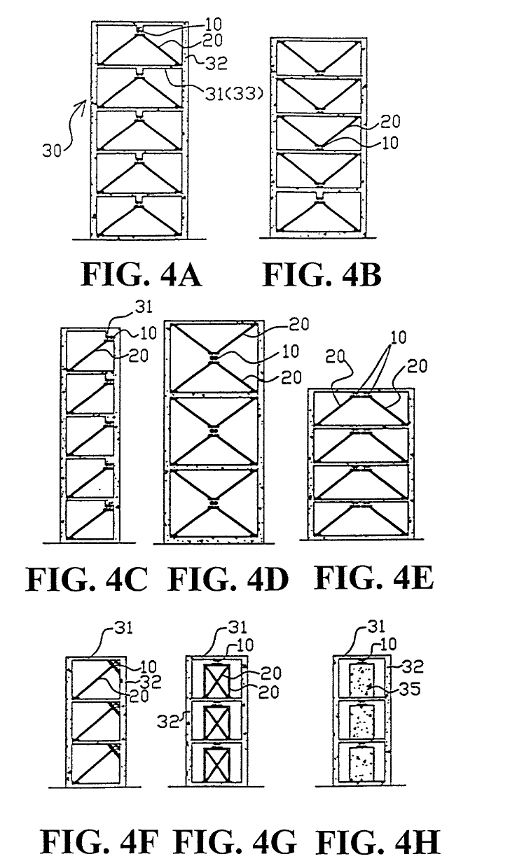

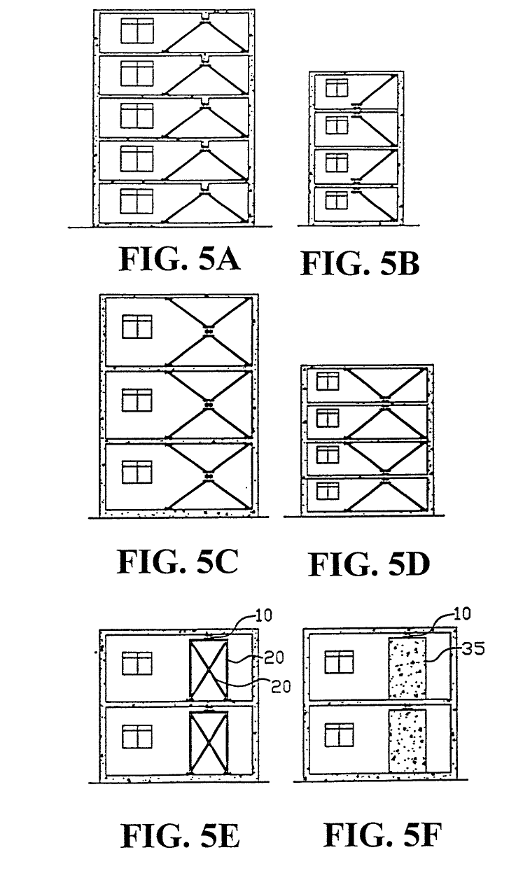

Referring to FIG. 1, a shock damper is shown comprising a damper body 10 and braces 20 supporting the damper body 10. The damper body 10 is comprised of a horizontal top plate 11, a horizontal bottom plate 12, and a vertical connecting device 13 connected between the top plate 11 and the bottom plate 12. The top plate 11 and the bottom plate 12 are rectangular plates, each having four axle holes 111; 121 in the four comers thereof. The top plate 11 and the bottom plate 12 may be arranged in parallel, or in a crossed manner. According to the embodiment shown in FIG. 1, the top plate 11 and the bottom plate 12 are arranged at different elevations in a crossed manner. Referring to FIGS. 1 through 5, respective screws 40 are mounted in the axle holes 111 of the top plate 11 of the damper body 10 to fixedly secure the top plate 11 to the bottom of the structural beam 31 of the structure 30. A top locating plate 21 is closely attached to the bottom of the bottom plate 12 and fixedly fastened to the axle holes 121 of the bottom plate 12 by screws. The braces 20 are symmetrically arranged at two sides, each having a top end connected to the bottom of the locating plate 21, and a bottom end connected to a bottom locating plate 22, which is fixedly fastened to the inside of the column 32 or floor by respective studs 40. The braces 20 may be arranged in two sets to form a V-shaped profile or an inversely disposed V-shaped profile. Thus, the beam 31 and column 32 of the structure 30 and the damper body 10 and braces 20 of the shock damper of the present invention are joined together. When an earthquake occurs, the connecting device 13 is deformed to absorb earthquake energy, so the structure 30 bears little earthquake energy and, is free from damage by the earthquake. In order to fit different structures, the braces 20 may be tilted in one direction to support the damper body 10 against apart of the building (see FIGS. 3A, 3B, 4C, 4F, and 5B). The present invention may be variously embodied to fit different structural constructions. For example, the damper body 10 may be supported between two sets of braces 20 that are respectively arranged into a V-shaped profile or an inversely disposed V-shaped profile at the top or bottom side of the damper body 10, forming a shock damper with an X-shaped profile (see FIGS. 4D and 5C); two damper bodies 10 may be incorporated with braces 20 to form a shock damper of V-shaped profile or inversely disposed V-shaped profile (see FIG. 4E); damper bodies 10 may be installed in structures or shearing walls formed of beams 31 and braces 20 (see FIGS. 4G, 4H, 5E, and 5F).

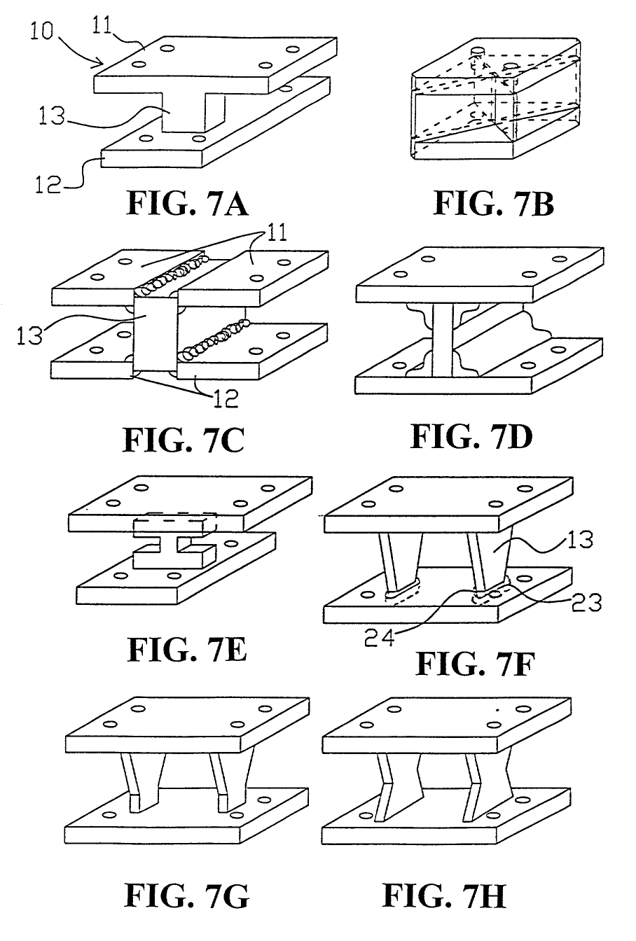

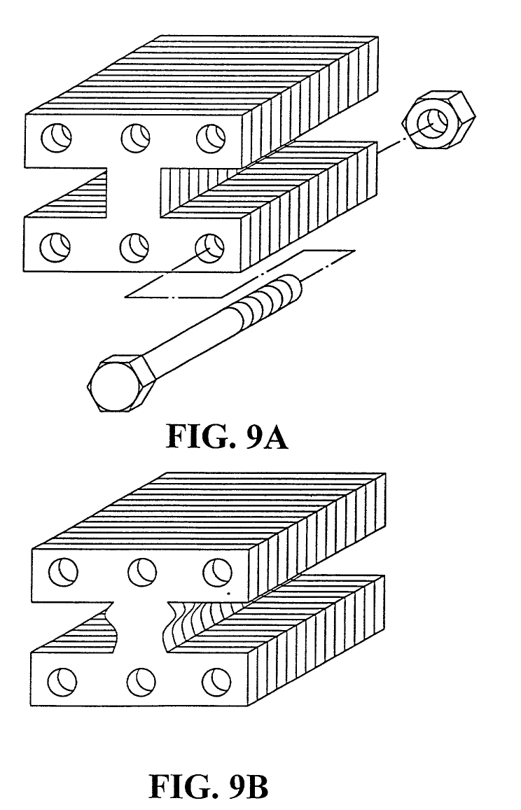

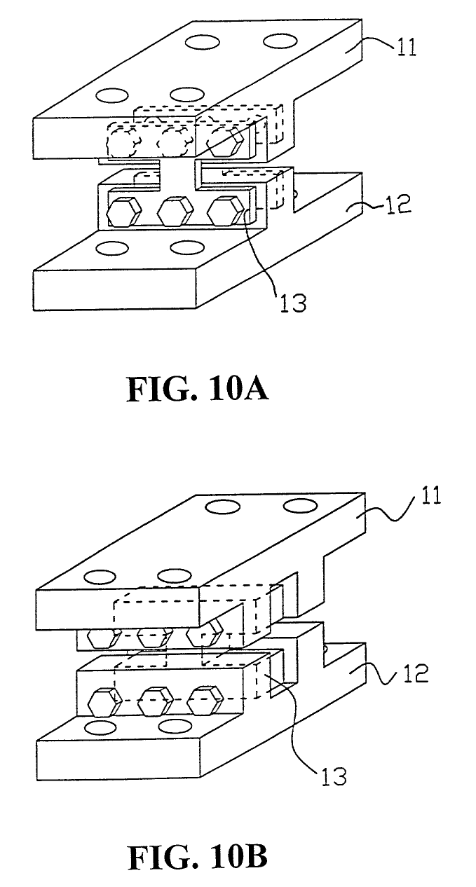

Basically, the damper body 10 is formed of top plate 11, a bottom plate 12, and a connecting device 13 supported between the top plate 11 and the bottom plate 12. By means of braces 20, the damper body 10 is firmly secured to the beam 31 and column 32 of the structure 30. Upon an earthquake, the relatively lower strength of the connecting device 13 is deformed to absorb shock waves from the earthquake. The connecting device 13 may be variously embodied. For example, the connecting device 13 can be made having any of a variety of cross sections including oval cross section, double-trapezoidal cross section, rhombic cross section, circular cross section, triangular cross section, trapezoidal cross section, rectangular cross section, polygonal cross section, or the like. The connecting device 13 can also be made having a crossed structure connected between the top plate 11 and the bottom plate 12, as shown in FIG. 7B. According to the embodiment shown in FIG. 7C, the top plate 11 and the bottom plate 12 each are formed of two symmetrical plate members respectively bilaterally welded to the top and bottom sides of the connecting device 13. According to the embodiment shown in FIG. 7E, the connecting device 13 is shaped like an I-bar. According to the embodiment shown in FIG. 7F, the connecting device 13 is comprised of two V-shaped plates connected in parallel between the top and bottom plates, and the V-shaped plates of the connecting devices 13 each have a bottom end welded with a horizontally extended cylindrical rod (or a spherical member) 23 and pivoted to a hole 24 in the bottom plate. According to the embodiments shown in FIGS. 7G and 7H, the connecting device 13 is comprised of two Y-shaped or X-shaped plates. According to the embodiments shown in FIGS. From 8A˜8C, the top plate 11 and the bottom plate 12 each have a plurality of transversely or longitudinally extended locating grooves 112 or 122 on the bottom plate 12 or top plate 11, and the connecting device 13 is comprised of a plurality of I-bars respectively fitted with the respective horizontal top or bottom section 131 into the locating grooves 112 and 122 of the top plate 11 and the bottom plate 12. According to the embodiment shown in FIGS. 9A and 9B, the connecting device 13 is comprised of a stack of I-shaped plates fastened together by screw bolts. FIGS. 10A and 10B show that the top and bottom plates 11 and 12 each have a T-shaped profile, and the connecting device 13 is comprised of a stack of I-shaped plates connected between the T-shaped top plate 11 and the T-shaped bottom plate 12. Further, a transverse connecting member may be connected between each two adjacent plates of the connecting device 13 to keep the plates of the connecting device 13 in balance. As indicated above, the present invention provides a simple shock damper, detachable and replaceable, installed in a structure to absorb shocks.

A prototype of shock damper has been constructed with the features of FIGS. 1˜10. The shock damper functions smoothly to provide all of the features discussed earlier.

It will be understood that each of the elements described above, or two or more together, may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A shock damper comprising:
at least one damper body respectively installed in the frame of a structure and adapted to absorb shocks from the said structure, the said at least one damper body each comprising a horizontal top plate, a horizontal bottom plate, and a vertical connecting device connected between the said horizontal top plate and the said horizontal bottom plate, the said connecting device having any of a variety of cross sections and a structural strength weaker than the said horizontal top plate and the said horizontal bottom plate such that the said connecting device is deformed to absorb shocks when said structure encountering an earthquake; and
supporting means adapted to secure the said at least one damper body to the beam and column of the frame of the said structure by studs, the said supporting means comprising a plurality of braces.

2. The shock damper of claim 1 wherein the horizontal top plate and horizontal bottom plate of each of the said at least one damper body are flat plate members each having a set of locating grooves respectively facing each other, and the connecting device of each of the said at least one damper body is comprised of a plurality of I-bars engaged into the said locating grooves and supported between the horizontal top plate and horizontal bottom plate of the respective damper body.

3. The shock damper of claim 1 wherein the horizontal top plate and horizontal bottom plate of each of the said at least one damper body are rhombic plate members each having a set of locating grooves respectively facing each other, and the connecting device of each of the said at least one damper body is comprised of a plurality of plates respectively engaged into the said locating grooves and supported between the horizontal top plate and horizontal bottom plate of the respective damper body.

4. The shock damper of claim 1 wherein the horizontal top plate and horizontal bottom plate of each of the said at least one damper body are rhombic plate members, and the connecting device of each of the said at least one damper body is comprised of a plurality of metal I-bars or plates with an I shaped cross section vertically connected between the horizontal top plate and horizontal bottom plate of the respective damper body.

5. The shock damper of claim 1 wherein the horizontal top plate and horizontal bottom plate of each of the said at least one damper body are flat plate members each having a set of locating grooves respectively facing each other, and the connecting device of each of the said at least one damper body is comprised of a plurality of triangular plates respectively engaged into the said locating grooves and supported between the horizontal top plate and horizontal bottom plate of the respective damper body.

6. The shock damper of claim 1 wherein the connecting device of each of the said at least one damper body is comprised of a plurality of V-shaped plates vertically connected between the horizontal top plate and horizontal bottom plate of the respective damper body.

7. The shock damper of claim 1 wherein the connecting device of each of the said at least one damper body is comprised of a plurality of plates vertically supported between the horizontal top plate and horizontal bottom plate of the respective damper body, and the plates of the connecting device of each of the said at least one damper body each having a bottom side welded with a horizontally extended cylindrical rod member supported on the horizontal bottom plate of the respective damper body.

8. The shock damper of claim 7 wherein the said cylindrical rod member has a locating groove adapted to receive the respective plate of the respective connecting device.

9. The shock damper of claim 7 wherein the bottom plate of the connecting device of each of the said at least one damper body has a plurality of holes, and the cylindrical rod members of the plates of the connecting device of each of the said at least one damper body are respectively pivoted to the holes of the bottom plate of the connecting device of each of the said at least one damper body.

10. The shock damper of claim 1 wherein the connecting device of each of the said at least one damper body is comprised of a plurality of plates vertically supported between the horizontal top plate and horizontal bottom plate of the respective damper body, and the plates of the connecting device of each of the said at least one damper body each having a bottom side welded with a spherical member supported on the horizontal bottom plate of the respective damper body.

11. The shock damper of claim 10 wherein the said spherical member has a locating groove adapted to receive the respective plate of the respective connecting device.

12. The shock damper of claim 10 wherein the bottom plate of the connecting device of each of the said at least one damper body has a plurality of holes, and the spherical members of the plates of the connecting device of each of the said at least one damper body are respectively pivoted to the holes of the bottom plate of the connecting device of each of said at least one damper body.

13. The shock damper of claim 1 wherein the connecting device of each of the said at least one damper body is comprised of a plurality of X-shaped supporting members respectively supported between the horizontal top plate and horizontal bottom plate of the respective damper body.

14. The shock damper of claim 1 wherein the connecting device of each of the said at least one damper body is comprised of a plurality of I-bars respectively fitted into respective grooves on the horizontal top plate and horizontal bottom plate of the respective damper device and then fixedly secured thereto by one of the fastening means including welding, adhesive means, and screw joints.

15. The shock damper of claim 1 wherein the connecting device of each of the said at least one damper body is comprised of a plurality of T-bars respectively supported between the horizontal top plate and horizontal bottom plate of the respective damper body.

16. The shock damper of claim 1 wherein the connecting device of each of the said at least one damper body is comprised of a stack of I-shaped plates fastened together by screw bolts and supported between the horizontal top plate and horizontal bottom plate of the respective damper body.

17. The shock damper of claim 1 wherein the connecting device of each of the said at least one damper body is comprised of a stack of I-shaped plates fastened together by screw bolts and supported between the horizontal top plate and horizontal bottom plate of the respective damper body and fixedly secured to the structure.

18. The shock damper of claim 1 wherein the connecting device of each of the said at least one damper body is comprised of a stack of T-shaped metal plates fastened together by one of the fastening means including welding, adhesive means, and screw joints, and supported between the horizontal top plate and horizontal bottom plate of the respective damper body.
